(19) United States
(12) Patent Application Publication
(10) Pub. No.: US 2007/0295372 A1
(43) Pub. Date: Dec. 27, 2007

(54) Device for passive microfluidic washing using capillary force

(75) Inventors: Haesik Yang, Busan (KR); Byung-Kwon Kim, Busan (KR); Sang-Youn Yang, Busan (KR)

Correspondence Address: EDWARDS ANGELL PALMER & DODGE LLP, P.O. BOX 55874, BOSTON, MA, 02205, US

(73) Assignee: Institute for Research & Industry Cooperation, Pusan National University, Busan (KR)

(21) Appl. No.: 11/820,902

(22) Filed: Jun. 21, 2007

(30) Foreign Application Priority Data
Jun. 22, 2006 (KR) 10-2006-0056561

(51) Int. Cl. B08B 3/00

(52) U.S. Cl. 134/94.1

(57) ABSTRACT

The present invention provides a microfluidic device, comprising: a substrate; a sample solution inlet provided on the substrate for introducing a sample solution; a washing solution inlet provided on the substrate for introducing a washing solution; a washing valve provided on the substrate at which the sample solution and the washing solution stops and in which passive washing is induced by pressure difference between the sample solution inlet and the washing solution inlet when the sample solution and the washing solution join together; and a plurality of channels connecting the sample solution inlet and the washing solution inlet to the washing valve, within which channels the sample solution and the washing solution can move by capillary force.

### CROSS-REFERENCE TO RELATED APPLICATION

The present application claims, under 35 U.S.C. §119(a), the benefit of the filing date of Korean Patent Application No. 10-2006-0056561 filed on Jun. 22, 2006, the entire contents of which are hereby incorporated by reference.

### BACKGROUND OF THE INVENTION

1. Technical Field

The present invention relates to a device for passive microfluidic washing by using capillary force, particularly to a microfluidic device which can eliminate the use of mechanical pump and valve and which readily control the washing volume and rate.

2. Background Art

Microfluidics is used for controlling small volumes of fluids on microchips. Intensive researches have been made to develop and improve microfluidic systems. An example of such researches provided a system involving micropumps, valves and mixing.

Microfluidics provides many advantages. One of the advantages is to make it possible to reduce the time taken for biochemical analyses and the amount of samples used in such analyses. Another advantage is to make it possible to assay various substances simultaneously for a reduced time.

In microfluidic washing technology, however, no great advances have been made, which is a major setback for commercialization of microchips using microfluidics.

In biochemical assays using microchips, the presence and concentration of analytical substances are confirmed by biospecific binding of biomolecules. The specific and selective reactions mostly occur on the solid surface of a heterogeneous phase, and substances which are not involved in such specific reactions, are removed by washing, before measuring signals. Such washing process reduces the background signal, thereby improving the sensitivity of a signal to be measured. In order to ensure precise assay, it is essential to perform such washing process in a simple, effective and rapid manner.

For washing microfluids in a microchip, methods using a mechanical pump have been mostly used. In these methods, washing is carried out by connecting a mechanical pump such as a syringe pump or a peristaltic pump to a microchip via a flow channel, and injecting a solution into the microchip or drawing the solution therefrom, when washing is necessary. However, these methods have problems in that connecting a microchip and a mechanical pump is not easy; the number of pumps should be increased in proportion to the number of times the washing process is carried out; and it is difficult to carry out the washing several times consecutively in time. Further, they also have a problem that an increase in the number of pumps requires a large system, although the microchip has a small volume.

Another methods used for microfluidic washing utilize centrifugal force, electroosmotic pressure or electrochemical pumping. Devices using centrifugal force, however, have a problem of controlling the rotation rate appropriately, in order to adjust the centrifugal force (U.S. Pat. No. 6,143,248). Devices using electroosmotic pressure also have problems of requiring a high voltage power supply, particularly when several repetitions of the washing are needed, and multiple number of such power sources. Further, devices using electrochemical pumping, in which washing is performed by the pressure of an oxygen or hydrogen gas generated during oxidation or reduction of water, have problems in that an additional preparation process is required for inducing an electrochemical reaction in a microchip and it is difficult to maintain a solution being tightly closed in the microchip. As it has been described above, washing methods using a mechanical pump or other means are disadvantageous in that the microfluidic control is not easily achieved, and the overall system and microchip fabrication process are complex.

U.S. Pat. No. 6,057,149 discloses a method for microfluidic washing by using changes of surface tension derived by temperature change. This method, however, has problems that fine temperature control on a microchip is difficult and it involves a complicated fabrication process therefor.

Capillary-driven flow using capillary force utilizes a phenomenon that a fluid naturally flows by the power of surface tension, without an action of a separate exterior pump. Based on such capillary-driven flow, many simple and economical disposable analytical products for biochemical assays have been developed, such as a pregnancy test kit or the like. Most of such products use porous materials for inducing a capillary flow. Theses products, however, involve the use of only one solution for carrying out such analysis, not using two or more solutions even though it is essential to use two or more solutions for carrying out more diverse and complex assays.

U.S. Pat. No. 6,271,040 discloses a method where a capillary flow is made in a microchannel without using a porous material. Although the method uses capillary force, only one sample solution is used for the microfluidic washing. Therefore, this method involves significant problems in that the volume of a sample solution needs to be increased for washing, and it is difficult to remove background signals occurring due to the increased volume of a sample solution. For precise assay, it is necessary to ensure clear washing with another solution.

Korean Patent Nos. 0444751 and 0471377 provide techniques for washing a sample solution present in a microchip by using a washing solution, for washing, instead of a sample solution, owing to capillary force. However, these methods, disadvantageously, require a big waste chamber, and it is difficult to control the washing rate and volume. Further, they have a problem in that another reaction chamber is required when carrying out a washing process twice or more times. It means that the washing process cannot be performed twice or more times in only one reaction chamber.

Accordingly, there is still a need for a new washing technique using capillary force, which can achieve fluid control in a simple manner and to easily fabricate a microchip.

### BRIEF SUMMARY OF THE INVENTION

For overcoming the problems of the prior art, the object of the present invention is to provide a microfluidic device, which makes it possible to simply control the fluid movement, to easily fabricate a device, and to control the washing volume and rate, wherein the flow, stop, washing of a fluid are governed by capillary force.

Further, another object of the present invention is to provide a microfluidic device, which can facilitate the delivery of a solution from an exterior system to the microfluidic device, while minimizing the size of the entire device.

The objects and advantages of the present invention will be clearly understood by skilled persons in the art, based on the following illustrative examples of the present invention with reference to the drawings attached hereto.

The present invention provides a device for controlling a microfluid, which induces a fluid flow with capillary force, and conducts microfluidic washing by using a washing solution other than a sample solution, wherein the washing occurs passively due to by pressure difference between two solution inlets of the sample and washing solutions.

The present invention provides a device for controlling a microfluid, which uses a washing valve so that washing is occurs after a sample solution and a washing solution come into contact, wherein washing is delayed until two solutions do join together, although either one of the sample solution and the washing solution may arrive at the washing valve ahead of the other.

The present invention provides a device for controlling microfluid, wherein a washing solution moves from a washing solution inlet toward a sample solution inlet by adjusting the pressure between said two solution inlets, and the washing volume is determined by the size of both inlets and the volume of both solutions.

Further, the present invention provides a device for controlling a microfluid, which controls the washing rate by adjusting fluidic resistance between a washing solution inlet and a washing valve, as well as the reaction time by adjusting the time taken for a solution to move from the washing solution inlet to the washing valve.

The present invention provides a device for controlling a microfluid, in which washing volume, rate and reaction time are also controlled by the shape and surface tension of microchannel, and surface tension of solution.

The present invention provides a device for controlling a microfluid, which removes substances not bound to the solid surface in a reaction chamber, or supplies substances to be newly bound to the solid surface by washing.

The present invention provides a device for controlling a microfluid, which does not necessitate a waste chamber by transferring a waste solution generated during a washing process to a sample solution inlet.

Further, the present invention provides a device for controlling a microfluid, which allows washing to be carried out twice or more times in a single chip.

### BRIEF DESCRIPTION OF THE DRAWINGS

These, and other features and advantages of the invention, will become clear to those skilled in the art from the following detailed description of the preferred embodiments of the invention rendered in conjunction with the appended drawings in which like reference numerals refer to like elements throughout, and in which:

FIG. 1a is a plan view of a microfluidic device according to a preferred embodiment of the present invention.

FIG. 1b is a cross-sectional view of the microfluidic device of FIG. 1a.

FIG. 2 is a view demonstrating that a fluid, when it is present in a microchannel, moves therethrough without any pressure applied from the outside owing to capillary force.

FIG. 3 is a view demonstrating changes in the shape of a solution with lapse of time at a solution inlet.

FIG. 4 is a view demonstrating changes in solution movement with lapse of time in a washing valve.

FIG. 5 is a view demonstrating changes in capillary pressure, depending on the volume of a solution drop at a solution inlet.

FIG. 6 is a view demonstrating changes in capillary pressure before and after washing.

FIG. 7a is a plan view of a microfluidic device comprising a reaction chamber according to a preferred embodiment of the present invention.

FIG. 7b is a cross-sectional view of a microfluidic device comprising a reaction chamber according to a preferred embodiment of the present invention.

FIG. 8 is a plan view of a microfluidic device where washing can be carried out twice according to a preferred embodiment of the present invention.

FIG. 9 is a view demonstrating a washing process and reactions occurring in a reaction chamber.

FIG. 10 is a photo showing changes in the shape of each solution drop at a solution inlet and a washing solution inlet.

FIG. 11 is a photo showing the process for washing a fluorescent substance in a reaction chamber during a passive washing process.

FIG. 12 is a plot showing changes in the fluorescence intensity (% washed area) as a function of time.

FIG. 13 is a view illustrating a quantitative analysis process of biotin-4-fluorescein by using a passive washing process, as well as a plot showing the fluorescence intensity as a function of concentration.

### DETAILED DESCRIPTION OF THE PREFERRED EMBODIMENTS

Hereinafter, preferred embodiments of the present invention will be described with reference to the drawings attached to this specification.

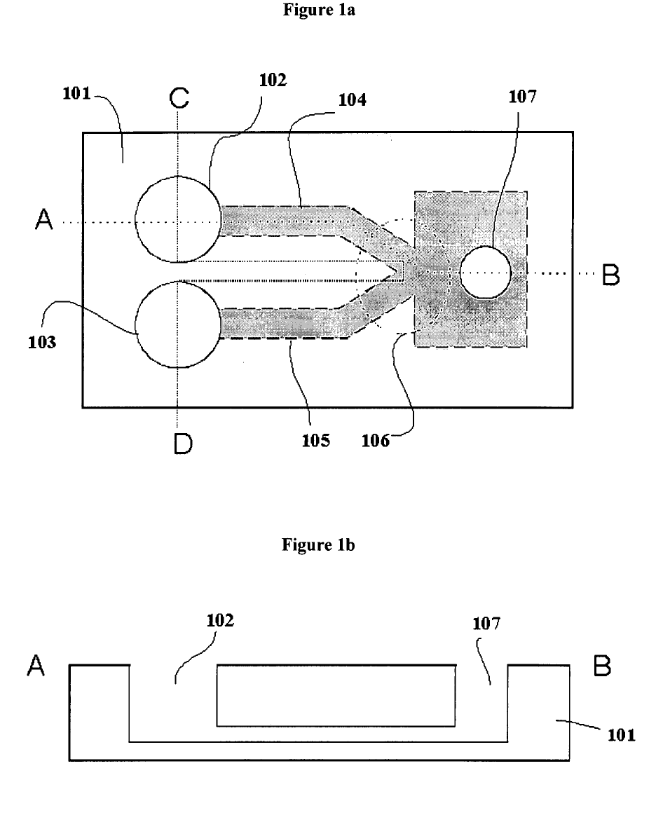

FIG. 1a is a plan view of a microfluidic device capable of washing a microfluid, according to the present invention. FIG. 1b is a cross-sectional view of a microfluidic device of FIG. 1a, when cutting along the line A-B.

The microfluidic device is comprised of: a substrate (101) made of, for example, plastic; a sample solution inlet (102); a washing solution inlet (103); a washing valve (106); a sample solution inlet (102); a connecting channel (104) between the sample solution inlet (102) and the washing valve (106); a fluid resistant channel (105) between the washing solution inlet (106) and the washing valve (106); and an air vent (107).

When a sample solution is dropped onto a sample solution inlet (102) through a pipette, a dispenser or the like, the sample solution droplet fills the sample solution inlet (102) and then moves as a capillary flow so as to fill the connecting channel (104). Upon arriving at the washing valve (106), the sample solution is naturally halted owing to capillary force. Similarly, when a washing solution is dropped into a washing solution inlet (103) through a pipette or a dispenser, the washing solution droplet fills the washing solution inlet (103) and then moves as a capillary flow so as to fill the fluid resistant channel (105). When the washing solution reaches the washing valve (106), it comes into contact with the sample solution. Preferably, an air vent (107) can be provided to prevent a pressure from being generated and affecting the movement of the washing solution and the sample solution.

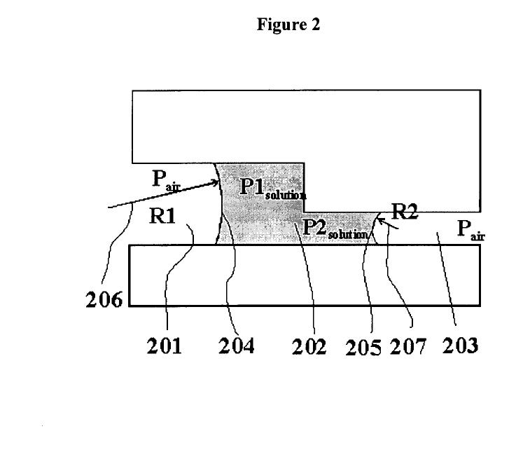

FIG. 2 is a view demonstrating that a solution, if any, present in a microchannel, moves owing to capillary force without application of any pressure from the outside. If the contact angle of a microchannel is 90° or less, the solution will have two concave interfaces (204, 205). Each interface forms a curvature with a radius of R1 (206) and R2 (207). Depending on the size of each radius, R1 (206) and R2 (207), the capillary pressure between the solution (202) and air (201,203) changes. The change in capillary pressure (ΔP) at the interface (204) having a radius of R1 (206) is P1ₛₒₗᵤₜᵢₒₙ−Pair. The change in capillary pressure (ΔP) at the interface (205) having a radius of R2(207) is P2ₛₒₗᵤₜᵢₒₙ−Pair. When the microchannel has a round shape, the capillary pressure can be represented by the following equation:
ΔP=2σ/R or −2σ/R
wherein, σ is the surface tension of an solution, and R is the radius of an interfacial curvature. As shown in FIG. 2, when R1 (206) is larger than R2 (207), the capillary pressure at the two interfaces (204, 205) becomes different, and naturally the solution starts to move from the larger channel to the smaller channel. Similarly, when such difference in capillary pressure is generated between the solutions at a sample solution inlet (102) and a washing solution inlet (103), the solutions will start to move without a pumping action applied from the outside, based on the same principle as shown in FIG. 2.

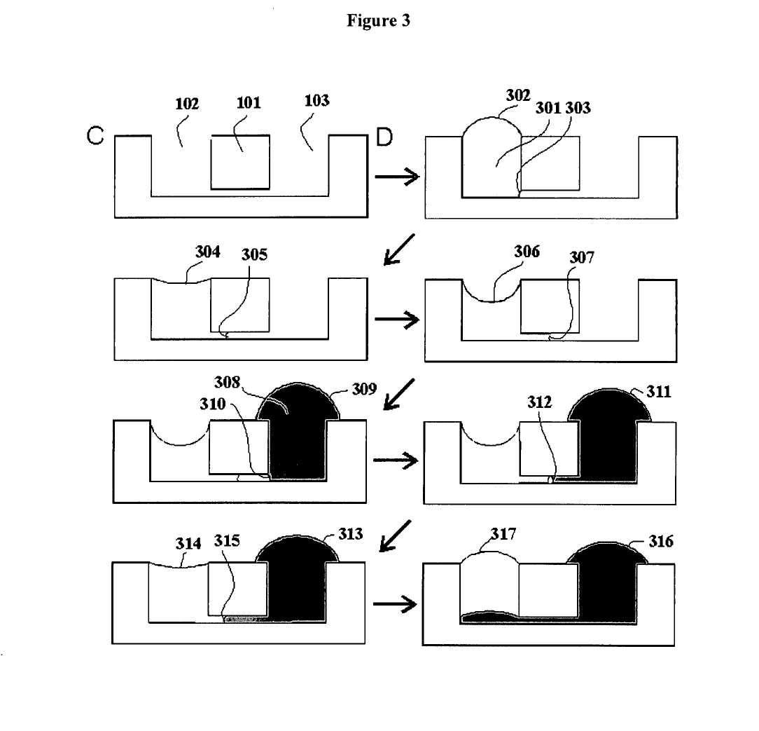

FIG. 3 is a cross-sectional view of FIG. 1, being cut along the line C-D, which demonstrates the time-based morphological changes of a solution. When a sample solution (301) is filled into a sample solution inlet (102), two interfaces (302, 303) between the solution and air are formed on each side, and then the solution starts to flow toward a microchannel owing to the capillary pressure difference between the two interfaces. As the solution flows toward and fills the microchannel, the shape of the solution interface (304) at the sample solution inlet (102) becomes changed, and the interface (305) on the microchannel side keeps moving forward. When the solution reaches the washing valve (106) where the microchannel is expanded in its width, the solution movement is stopped by capillary force, forming, on the sample solution inlet (102) side, an interface (306) having a curvature with a larger radius, and on the microchannel side, an interface (307) at a standstill. When a washing solution (308) is added to the washing solution inlet (103), it also forms two interfaces (309, 310). The washing solution flows forward in the microchannel by capillary force, making some changes in the two interfaces (311, 312). The capillary pressures of the two interfaces (313, 314) at both solution inlets (102, 103) play an important role when the washing solution and the sample solution come into contact. The interface (314) at the sample solution inlet will have capillary pressure with a negative value, while the interface (313) at the washing solution inlet will have capillary pressure with a positive value. Owing to such difference, the washing solution moves toward the sample solution inlet. Since the solution movement is made by the pressure difference, the boundary surface (315) between the two solutions will have a parabolic shape. The washing solution keeps moving, until the capillary pressures at the two inlets (102, 103) become equal. Ultimately, the curvature radiuses of each solution interface (316, 317) at the two inlets will have the same value. Since the washing solution (308) moves to the sample solution inlet (102) after washing the microchannel, the sample solution inlet (102) also serves as a waste chamber.

Although the sample solution (301) is introduced before the washing solution (308) is introduced in FIG. 3, the two solutions may be simultaneously added, or the washing solution (308) may be first introduced followed by the addition of sample solution (301). Even if either one of the solutions comes to the washing valve before the other, passive washing can occur regardless of the order of adding the solutions, since the solution arrived first will be at a standstill at the washing valve owing to capillary force, until it meets the other solution.

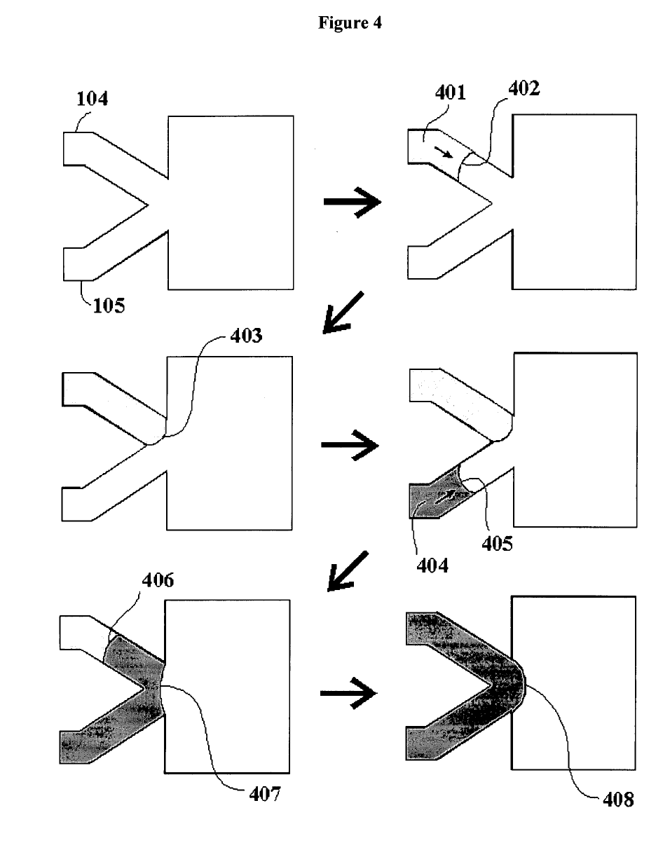

FIG. 4 is a view demonstrating changes in a solution movement with a lapse of time in a washing valve. A sample solution (401) comes forward and is stopped at the point where the channel width is expanded, in a washing valve wherein a connecting channel (104) and a fluidic resistant channel (105) are connected together. The shape of the sample solution interface (403) at this time becomes changed from that of the sample solution interface (402) in motion. When a channel width is expanded, it results in a big change in capillary force, stopping the solution. Other than changing the channel width, the same effect can be obtained by changing the shape of the channel or the surface contact angle. While a sample solution (401) is at a standstill, a washing solution (404) moves forward and the two solutions come to join at the junction of the two channels. When the two solutions join, the washing solution (404) moves toward the sample solution inlet (102), due to the pressure difference between the sample solution inlet (102) and the washing solution inlet (103). After the joining of the two solutions, the shape of the washing solution interface (406) is different from that of the washing solution interface (405) when it moves through the microchannel. At the point where the two solutions join, another new interface (407) is formed. After completion of the movement, another new interface (408) is formed.

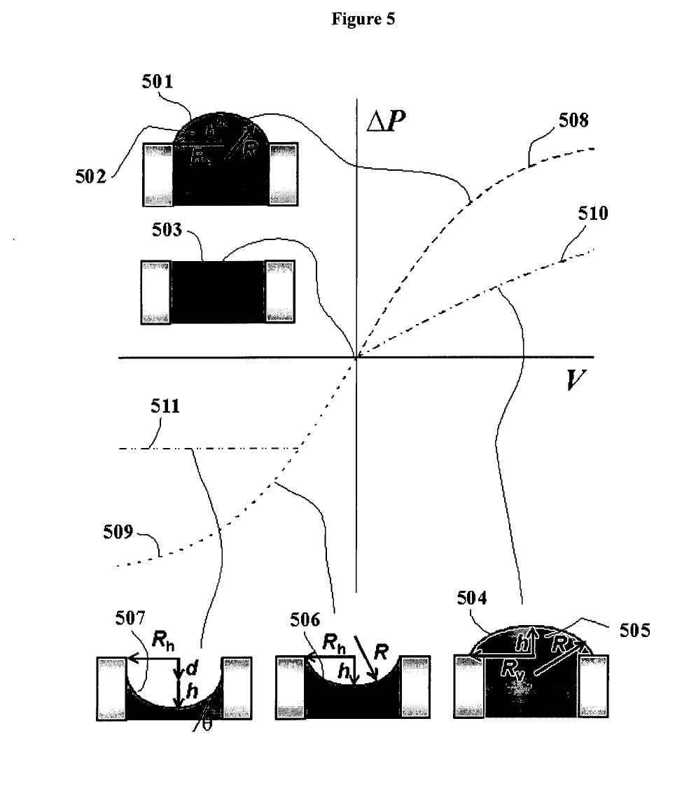

FIG. 5 is a view demonstrating changes in capillary pressure, depending on the volume of a solution drop (502) at the solution inlets (102, 103). It is defined that when the solution drop (502) convexly sticks out of the solution inlet, it has a positive volume, and when the solution drop (502) has a concave meniscus in the solution inlet, it has a negative volume. When the solution drop (502) convexly sticks out of the solution inlet, the capillary pressure at the interface (501) between the solution and air has a positive value. In the case of a round-shaped inlet, the volume and capillary pressure are determined by the following equation:
V=π/6×(h3+3Rh2h)
ΔP=2σ/R
wherein h is the height of a solution drop (502); Rh is the radius of the solution inlet. The pressure change according to the volume moves along the upper line (508) in the first quadrant. When the volume of the solution drop (502) becomes zero, the capillary pressure at the interface (503) also becomes zero. When the solution drop (502) has a concave meniscus, the capillary pressure and the volume at the interface (506) are determined by the following equation:
V=−π/6×(h3+3Rh2h)
ΔP=−2σ/R

In the case that the solution drop (502) convexly sticks out, the same equation is applied except that a minus sign is further added thereto. Therefore, in this case, the pressure change according to the volume moves along the line (509) in the third quadrant. When a solution drop (505) is stretched over a wider area including the solution inlet and surrounding area thereof, the capillary pressure and the volume at the interface (504) are determined by the following equation:
V=π/6×(h3+3Rv2h)
ΔP=2σ/R
wherein Rv is the average radius of a solution drop (505). In the case that evaporation is minimized, a volume reduction occurs with maintaining a certain contact area. The capillary pressure according to the volume changes along the lower line (510) represented in the first quadrant. When a solution drop (505) covers a wider area including the solution inlet and surrounding area thereof, it has a smaller capillary pressure for a solution drop with the same volume, as compared to when the solution drop (502) is present over the solution inlet. If a solution inlet is large, upon application of a solution, the interface (507) may not stick out of the solution inlet area, but form a concave meniscus in the solution inlet. In this case, the capillary pressure and the volume are determined by the following equation:
V=−π/6×(h3+3Rh2h)−πRh2d
ΔP=−2σ/Rh×cos θ
wherein d is the depth of the solution drop, and θ is the contact angle of the solution. In this case, a constant contact angle can be obtained regardless of the solution volume, and thus the capillary pressure is constant, too. The capillary pressure according to the volume, moves along the parallel line (511) in the third quadrant.

To sum up, the shape of a solution drop and the capillary pressure depend on the amount of solution being introduced into the solution inlet. Further, the shape of a solution and the capillary pressure also depend on the time taken for the solution to move to a microchannel, and the solution volume. When a sample solution and a washing solution come to join at a washing valve, the joined solution starts to move owing to the difference in the capillary pressure at the solution inlet part, and ultimately the difference in the capillary pressure becomes zero.

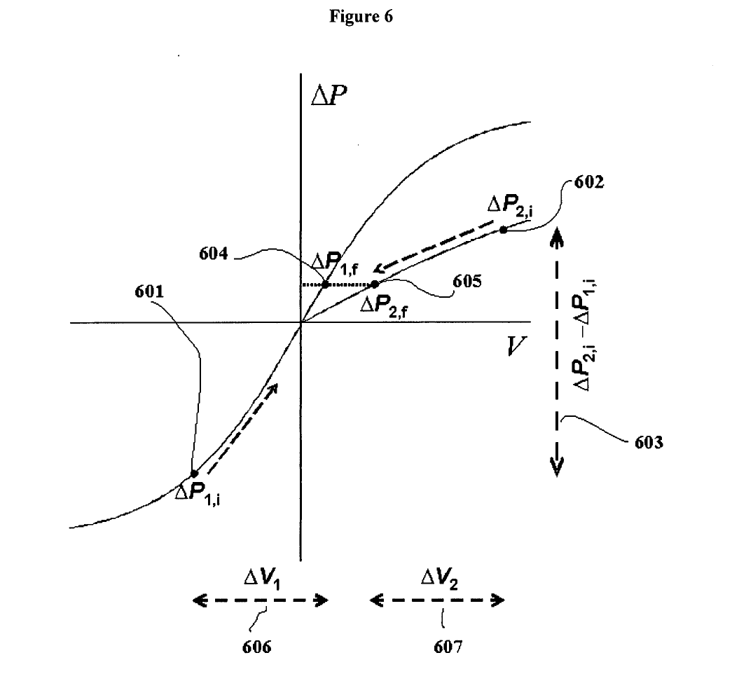

FIG. 6 is a view demonstrating changes in capillary pressure before and after washing. After a sample solution reaches a washing valve, the capillary pressure at a sample solution inlet (102) is adjusted to have a negative value (ΔP1,i) (601). For the capillary pressure of a washing solution, even if the washing solution reaches the washing valve, it is adjusted to have a positive value (ΔP2,i) (602) by providing a sufficient amount of washing solution to the washing solution inlet (103). Therefore, when a sample solution and a washing solution join together at the washing valve, a great difference (ΔP2,i−ΔP1,i) (603) will be generated in capillary pressure. Such pressure difference causes rapid washing. Then, the volume of the solution drop at the sample solution inlet (102) increases, and that of the solution drop at the washing solution inlet (103) decreases. At the point where the capillary pressure difference becomes zero, the solution flow stops. At this point, the capillary pressure (ΔP1,f) (604) at the sample solution inlet and the capillary pressure (ΔP2,f) (605) at the washing solution inlet becomes equivalent. The increased volume (ΔV1) (606) at the sample solution inlet (102) during the washing process becomes equivalent to the reduced volume (ΔV2) (607) at the washing solution inlet (103).

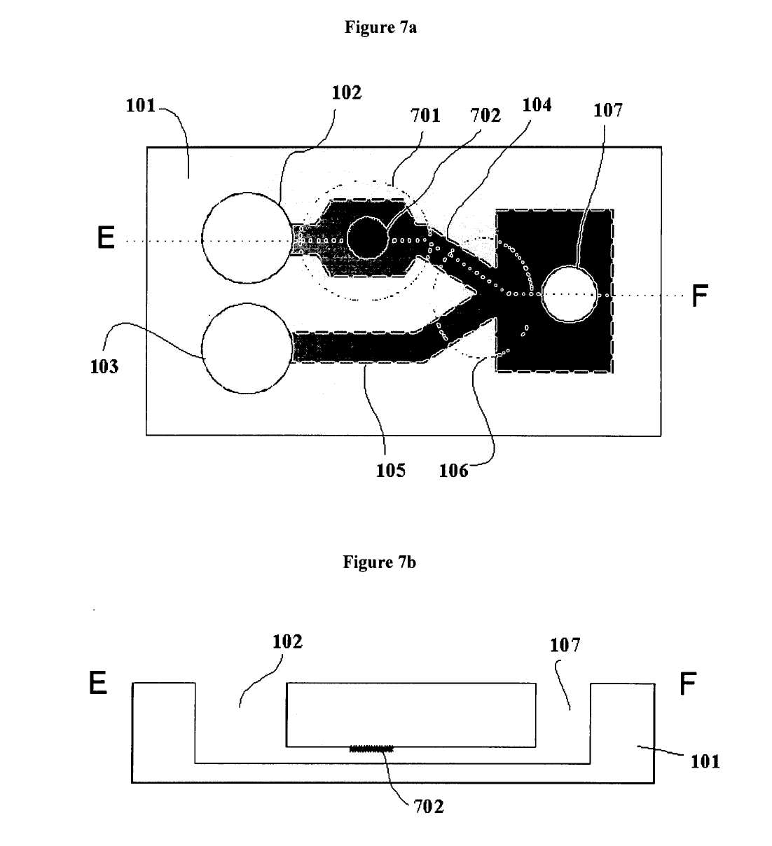

FIG. 7a is a plan view of a microfluidic device comprising a reaction chamber (701) provided in a connecting channel (104). FIG. 7b is a cross-sectional view of the device of FIG. 7a. In the reaction chamber (701), there is at least one solid surface (702) where adsorption, biospecific binding or the like can occur. Materials to be assayed, contained in a sample solution may be bound to the solid surface (702), and unbound materials are to be washed by a washing solution.

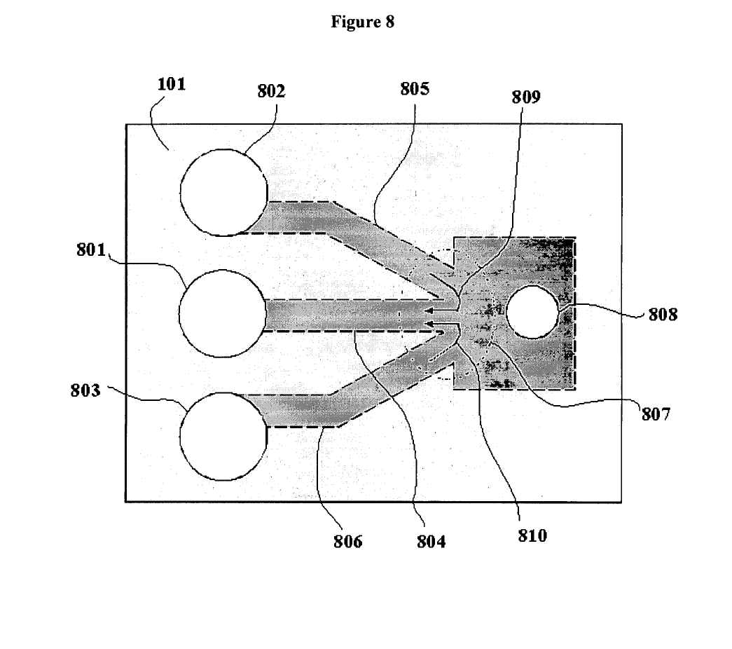

FIG. 8 is a plan view of a device where washing can be carried out twice. The device comprises two washing solution inlets (802, 803), while having only one sample solution inlet (801). A washing valve (810) is connected to a connecting channel (804) and two fluid resistant channels (805, 806). When a washing solution comes first to the washing valve through either one of the two fluid resistant channels (805, 806), a first passive washing (809) occurs. Then, when another washing solution reaches the washing valve through the other fluid resistant channel, a second passive washing (810) occurs. The first washing is caused by making the capillary pressure at the sample solution inlet (801) smaller than the pressure at the first washing solution inlet (802). Then, the second washing is caused by making the pressure at the sample solution inlet (801) after the first washing smaller than the pressure at the second washing solution inlet (803). In this way, for one sample solution inlet, three or more fluid resistant channels may be provided in order to carry out washing three times or more.

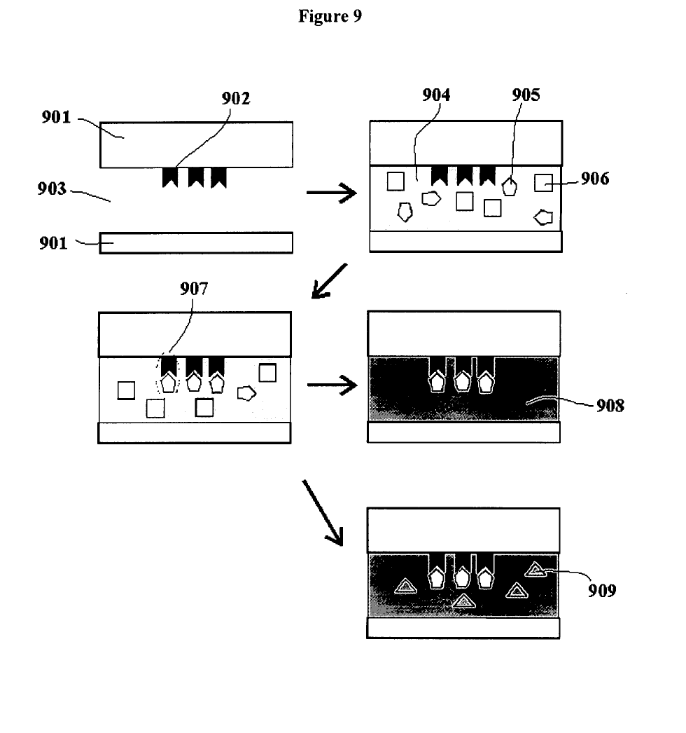

FIG. 9 is a view demonstrating washing process and reactions in a reaction chamber. To a substrate (901), a binding inducing material (902) which causes adsorption and biospecific bindings, is partially fixed, and it is placed into a reaction chamber (903). Then, the reaction chamber (903) is filled with a sample solution (904) comprising materials (905) which can be adsorbed or bound to the binding inducing material (902). In the sample solution (904), there are also materials (906) which are not to be bound to the binding inducing material (902). The materials (905) bound to the reaction chamber (903) are fixed (907) to the surface by adsorption to or biospecific binding with the binding inducing material (902). In order to facilitate such adsorption or biospecific binding on the surface, it is possible to give sufficient time before carrying out washing. When a washing solution (908) is applied to the sample solution (904) in the reaction chamber (903), materials which are not bound to the binding inducing material (902) will be washed out. If a washing solution contains materials (909) which are to be bound to or affect the materials (907) fixed to the surface, a secondary binding or other surface chemical reactions may occur through such washing solution.

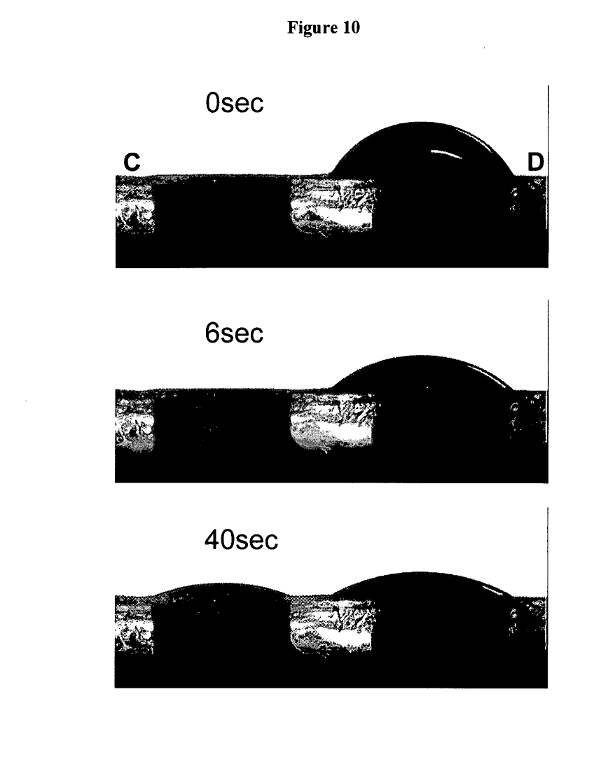

FIG. 10 illustrates changes in the shape of each solution drop at a solution inlet (102) and a washing solution inlet (103) during a washing process. It can be found that the shape of a drop is changed as represented in FIG. 3. Before passive washing, the solution drop at the sample solution inlet (102) has a concave meniscus, and the solution drop at the washing solution inlet (103) sticks out convexly. After passive washing, the volume of the solution drop at the sample solution inlet (102) is increased and sticks out convexly, and the volume of the solution drop at the washing solution inlet (103) is reduced. Ultimately, the curvature radii of the two solution drops become equal.

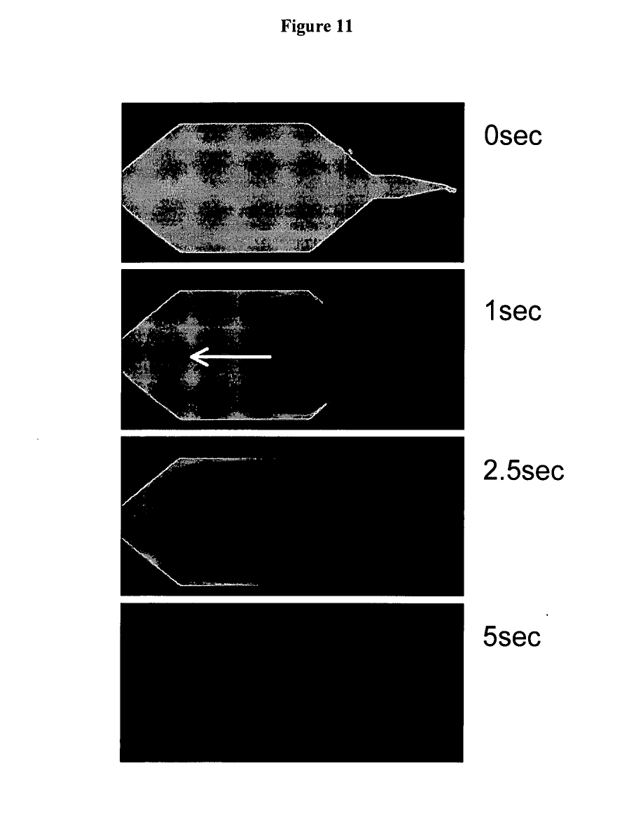

FIG. 11 is a plot showing changes in a fluorescent image depending on time, wherein a reaction chamber (701) is charged with a sample solution comprising a fluorescent material, Fluorescein, while using a device as represented in FIG. 7 which has a fluidic resistant channel (105) having a channel width of 350 μm, and then the reaction chamber (701) is washed. After 5 seconds, it can be confirmed that the square part of the reaction chamber (701) is completely washed. It is confirmed that the microfluidic washing by capillary force is performed very effectively.

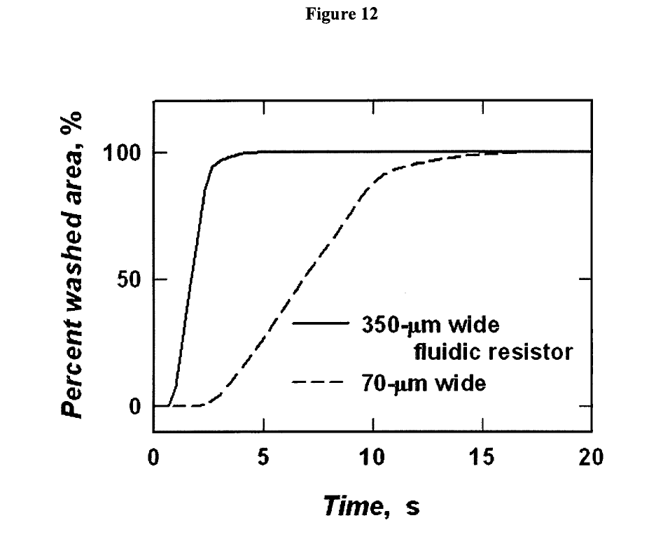

FIG. 12 is a plot showing changes in the fluorescence intensity as a function of time, which are obtained as in FIG. 11. The dotted line in the plot is obtained by using a fluidic resistant channel (105) having a width of 70 μm. As the channel width is reduced, the fluidic resistance increases, and it can be found that the washing process is carried out rather slowly. That means, it is possible to control the washing rate by adjusting the channel width.

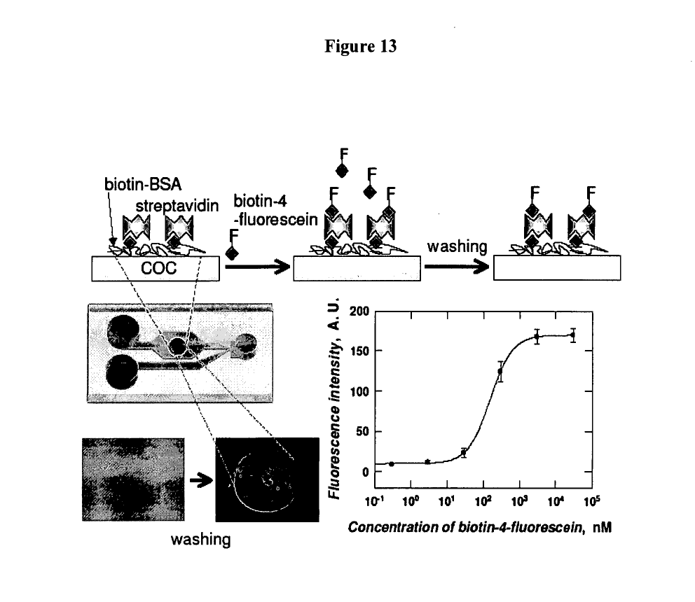

FIG. 13 shows a preferred embodiment of the present device where streptavidin is used as a binding inducing material in the solid surface (702). After allowing a sample solution comprising biotin-4-fluorescein to be flown to the surface, it is allowed for a biospecific binding between streptavidin and biotin-4-fluorescein to occur for 10 minutes. After that, a washing solution is introduced through a washing solution inlet (103), leading to passive washing by capillary force. Unbound biotin-4-fluorescein is washed away by the washing process, and the biotin-4-fluorescein bound to streptavidin only become fluorescent. By measuring the fluorescence intensity, the amount of biotin-4-fluorescein bound to the surface can be known. As a result, it is possible to quantify biotin-4-fluorescein present in the sample solution. By using such method, it is possible to measure materials to be assayed which are present in a sample solution with a small background signal, by fixing the materials to be assayed to a reaction chamber (701) and carrying out passive washing owing to capillary force.

As it has been described so far, according to the present invention, a microfluidic device is provided which can carry out passive washing in a rapid and simple way by using capillary force, and can easily control the washing volume and rate without requiring the use of a separate pump.

The microfluidic device of the present invention, wherein a solution is dropped through a pipette or a dispenser thereto and then advances as a capillary flow in the device, can be easily connected with an exterior system, so that it may be applied to carry-along type point-of-care testing devices in small size.

Further, the microfluidic device according to the present invention does not require a waste chamber, and washing can be carried out twice or more times in one reaction chamber, thereby being suitable for miniaturization.

The microfluidic device according to the present invention may be applied to all the biomems devices (lab-on-a-chip), which utilize bindings and reactions on a heterogeneous surface. Particularly, it can serve as a critical element of sandwich immunoassays, DNA sensors, and microreactors.

It is understood that various substitutions, modifications and variations may be made to the foregoing invention by ordinarily skilled persons in the art to which the present invention belongs, without departing from the scope of the technical spirit of the present invention. In this context, it is also understood that the present invention is not limited by the above-described examples and drawings attached hereto.

What is claimed is:

1. A device for controlling a microfluid comprising:
a substrate;
a sample solution inlet provided on the substrate for introducing a sample solution;
a washing solution inlet provided on the substrate for introducing a washing solution;
a washing valve provided on the substrate at which the sample solution and washing solution stops and in which passive washing is induced by pressure difference between the sample solution inlet and the washing solution inlet when the sample solution and the washing solution join together; and
a plurality of channels connecting the sample solution inlet and the washing solution inlet to the washing valve, within which channels the sample solution and the washing solution can move by capillary force.

2. The device according to claim 1, further comprising an air vent provided on the substrate for facilitating movement of the sample solution and the washing solution to the washing valve within the channels.

3. The device according to claim 1, wherein the passive washing rate is determined by: a material constituting the device and types of a washing solution; and shapes of the connecting channels and the washing valve.

4. The device according to claim 1, wherein the passive washing volume is determined by: the volume of a sample solution injected to the sample solution inlet and the volume of a washing solution injected to the washing solution inlet; and the volume of a solution required to fill the connecting channels, the sample solution inlet and the washing solution inlet.

5. The device according to claim 1, further comprising a reaction chamber within one of the channels that connects the sample solution inlet to the washing valve.

6. The device according to claim 5, wherein the washing solution has a washing function of removing species which are present in the reaction chamber without being fixed to the wall of the reaction chamber during passive washing, or a function of filling species which can be fixed to or react with the wall of the reaction chamber.

7. The device according to claim 5, wherein the passive washing is carried out after proceeding with a reaction in the reaction chamber for a period corresponding to the time taken for the transfer of a solution from the washing solution inlet to the washing valve, by adjusting the transferring time.

8. The device according to claim 1, further comprising at least one washing solution inlet and at least one channel connecting the washing solution inlet to the washing valve.
